(19) United States
(12) Patent Application Publication
(10) Pub. No.: US 2026/0277833 A1
(43) Pub. Date: Sep. 17, 2026

(54) Memory and Storage Control Coordination

(71) Applicant: Google LLC, Mountain View, CA (US)

(72) Inventor: Sathiyanarayanan Ravichandran, New Taipei City (TW)

(73) Assignee: Google LLC, Mountain View, CA (US)

(21) Appl. No.: 19/670,189

(22) Filed: May 7, 2026

(51) Int. Cl. G06F 13/16; G06F 13/38

(52) U.S. Cl. CPC G06F 13/1689; G06F 13/1673; G06F 13/387

(57) ABSTRACT

Moving large amounts of data from persistent storage to volatile memory involves significant data routing overhead that increases latency and consumes battery power. If an electronic device transitions to a deep sleep state to save power, restoring the system state data upon awakening is a slow process that negatively impacts device responsiveness. This document describes hardware and techniques that enable memory and storage control coordination. To accelerate data transfers, a local interconnect couples a storage controller to a memory controller. This arrangement allows the storage controller to bypass a coherent interconnect when sending data to the memory controller. By bypassing the coherent interconnect, the electronic device can avoid packetizing data into flits. Consequently, data transfer latency is reduced, enabling the electronic device to transition into aggressive power-saving states to extend battery life in a wider variety of scenarios.

### SUMMARY

This document describes hardware and techniques that enable memory and storage control coordination. Retaining massive amounts of data in volatile memory during idle periods can consume significant battery power. Powering down the volatile memory reduces power consumption but typically introduces severe wake-up latencies because restoring system state data from nonvolatile storage involves routing the system state data through a complex system-on-chip coherent interconnect. To address these issues, described implementations can utilize a local interconnect that couples a storage controller to a memory controller. This configuration permits the storage controller to bypass the coherent interconnect when communicating with the memory controller.

In some implementations, the storage controller and the memory controller can cooperate to translate from a storage-specific protocol to a memory-specific protocol. By bypassing a system bus protocol associated with the coherent interconnect, the controllers can avoid packetizing data payloads into flits and avoid appending protocol transaction overhead. In some cases, a direct memory access (DMA) engine coupled to the local interconnect can execute data transfers autonomously without oversight by a processor after the transfer is initiated. This dedicated controller-to-controller pathway enables the memory controller to stream data in contiguous chunks and maintain a dynamic random-access memory (DRAM) row in an open state to maximize bandwidth utilization.

In other implementations, an apparatus may transition into a suspend-to-disk (S2D) state where a volatile memory device is power-collapsed. An always-on subsystem can remain powered during the suspend-to-disk state to execute a wake-up sequence. Because the local interconnect accelerates data transfers, the suspend-to-disk state can be triggered based on a shortened actual or expected idle time, like ten minutes. To safely manage data traffic, a local system memory management unit (SMMU), which may have a hardware translation lookaside buffer (TLB), can perform address validation to confine storage-to-memory transfers to safe address ranges. Memory arbitration logic can also be employed at the memory controller to throttle data transfer speeds from the storage controller over the local interconnect to prevent processor bandwidth starvation.

In example implementations, an apparatus for memory and storage control coordination is described. The apparatus includes a coherent interconnect, at least one processor, a local interconnect, a memory controller, and a storage controller. The at least one processor is coupled to the coherent interconnect. The memory controller is coupled to the coherent interconnect and the local interconnect. The memory controller is configured to communicate with the at least one processor using the coherent interconnect. The storage controller is coupled to the local interconnect. The storage controller is configured to bypass the coherent interconnect by communicating with the memory controller using the local interconnect. Likewise, the memory controller can be configured to bypass the coherent interconnect by communicating with the storage controller using the local interconnect.

In example implementations, a method for memory and storage control coordination is described. The method includes communicating, by a memory controller coupled to a coherent interconnect and a local interconnect, with at least one processor using the coherent interconnect. The method also includes bypassing the coherent interconnect by communicating, by a storage controller coupled to the local interconnect, with the memory controller using the local interconnect. The method can further include bypassing the coherent interconnect by communicating, by the memory controller, with the storage controller using the local interconnect.

### BRIEF DESCRIPTION OF DRAWINGS

Apparatuses of and techniques for memory and storage control coordination are described with reference to the following drawings. The same numbers are used throughout the drawings to reference like features and components.

FIG. 1 illustrates an example apparatus including a system-on-chip (SoC) having a local interconnect coupled to a memory controller and a storage controller that can implement memory and storage control coordination.

FIG. 2 is an example schematic diagram of an SoC in which a memory controller and a storage controller lack control coordination and communicate across a coherent interconnect.

FIG. 3 is an example schematic diagram of an SoC in which a memory controller and a storage controller coordinate control and communicate across a local interconnect in accordance with memory and storage control coordination as described herein.

FIG. 4 illustrates example approaches to implementing memory and storage control coordination as described herein.

FIG. 5 illustrates other example approaches to implementing memory and storage control coordination as described herein.

FIG. 6 illustrates additional example approaches to implementing memory and storage control coordination as described herein.

FIG. 7 illustrates various components of an example electronic device that can implement memory and storage control coordination in accordance with one or more described aspects.

### DETAILED DESCRIPTION

### Overview

High-compute workloads, like artificial intelligence (AI) and machine learning (ML) models executing locally on electronic devices, utilize high-speed access to volatile memory and persistent storage. To reduce initial access latency, electronic devices often retain large memory footprints in a volatile memory device, like dynamic random-access memory (DRAM) (e.g., low-power double-data-rate (LPDDR) DRAM). Retaining this large memory footprint during idle periods relies on frequent self-refresh operations that consume a significant amount of power, sometimes accounting for 30 to 45 percent of device idle power. Powering off the volatile memory during deep sleep or suspend-to-disk (S2D) modes can extend battery life.

Unfortunately, restoring a system state from a persistent nonvolatile storage device, like an embedded MultiMediaCard (eMMC) or Universal Flash Storage (UFS) 3.1/4.0 device, typically incurs a severe wake-up delay. This delay arises because the nonvolatile storage data routes through a shared system-on-chip (SoC) network and a coherent interconnect, which utilize wrapping protocols like an Advanced eXtensible Interface (AXI) protocol that packetizes data into small flits (e.g., of 16 to 64 bytes). This multi-stage routing produces fabric congestion and significant latency-creating bottlenecks. Consequently, operating systems are usually designed or tuned to avoid deep sleep states for shorter idle periods.

To at least partially address these issues, this document describes hardware and techniques that enable memory and storage control coordination. For example, an electronic device includes an SoC having, in addition to a coherency interconnect, a local interconnect that couples a storage controller to a memory controller. This architecture allows storage-to-memory data transfers to bypass the central coherent interconnect entirely. By establishing a localized data-routing path, the architecture eliminates unnecessary data-routing protocol overhead, increases data throughput, and significantly reduces data access latency. These features enable the electronic device to, for instance, enter a suspend-to-disk state more frequently to save power.

In some implementations, an apparatus includes a coherent interconnect and at least one processor coupled to the coherent interconnect. The at least one processor can be realized with a central processing unit, a graphics processing unit, or an artificial-intelligence accelerator. The apparatus can also include a network interconnect and a video engine and a display engine coupled to the coherent interconnect via the network interconnect. The apparatus additionally includes a local interconnect, a memory controller, and a storage controller. The memory controller is coupled to the coherent interconnect and the local interconnect. This enables the memory controller to communicate with the processor using the coherent interconnect.

The storage controller is coupled to the local interconnect. To execute data transfers between a nonvolatile storage device coupled to the storage controller and a volatile memory device coupled to the memory controller, the storage controller bypasses the coherent interconnect by communicating with the memory controller using the local interconnect. Thus, the storage controller can avoid the protocol overhead and significant delays caused by the coherent interconnect by sending data from the storage controller to the memory controller using the local interconnect. Avoiding the shared, system-level coherent interconnect also increases data security by isolating the data during controller-to-controller transfers. These various interconnects, processors, engines, and controllers can be integrated together on a single system-on-chip (SoC).

By utilizing the local interconnect, the storage controller and the memory controller can cooperate to translate from a storage-specific protocol to a memory-specific protocol thus bypassing a system bus protocol corresponding to the coherent interconnect. In some cases, the two controllers can translate the protocols without packetizing the data in accordance with the system bus protocol. For example, this storage-to-memory protocol translation can avoid an AXI protocol that entails packetizing data payloads into flits and appending protocol transaction overhead. Because the local interconnect provides a dedicated pathway, the storage and memory controllers can stream the data using at least one buffer in contiguous chunks having a size of at least four kilobytes (4 KB). This buffering and chunk size allows the memory controller to execute a transfer that maintains a DRAM row in an open state, which is an efficient use of DRAM.

In some implementations, a direct memory access (DMA) engine is coupled to the local interconnect. The direct memory access engine can autonomously execute a transfer of data between the storage controller and the memory controller using the local interconnect and bypassing the coherent interconnect. The direct memory access engine may execute the transfer without oversight by the processor after the transfer of data is initiated by the processor. Furthermore, a local system memory management unit (SMMU) that is configured to manage data transfers propagated over the local interconnect can perform address validation for the data transfers and confine storage-to-memory transfers to predetermined safe address ranges. The local system memory management unit may include a hardware translation lookaside buffer (TLB) to facilitate the address validation.

In example operations, the reduction in data-transfer latency enables advanced power management functions to be supported. For instance, an electronic device can transition into a suspend-to-disk (S2D) state in which the volatile memory device is power-collapsed, and system state data is stored in the nonvolatile storage device. Because the local interconnect accelerates restoration of the operational state, the device can trigger the suspend-to-disk state based on a shortened idle threshold, like approximately ten (10) minutes of actual idle time or approximately fifteen (15) minutes of predicted idle time. This contrasts with legacy thresholds in the one-to-two-hour range to justify entering the suspend-to-disk state. Upon exiting the suspend-to-disk state, an always-on (AON) subsystem that remains powered during the suspend-to-disk state executes a wake-up sequence. The always-on subsystem triggers power to be supplied to the memory controller and the storage controller, streams the system state data across the local interconnect to bypass the coherent interconnect, and releases the processor from a reset state responsive to the streaming.

To prevent the localized, high-speed data streaming between controllers from starving processors of memory bandwidth, the memory controller can include memory arbitration logic. The memory arbitration logic allocates memory bandwidth between first data traffic with the coherent interconnect and second data traffic with the local interconnect. The memory arbitration logic can utilize priority-based arbitration logic configured to prioritize the first data traffic over the second data traffic. Alternatively or additionally, a signal path may be provided between the memory controller and the storage controller. The signal path enables the memory arbitration logic to transmit a signal to cause the storage controller to throttle a data transfer speed to increase available memory bandwidth for the processors. The various implementations can be used separately or together in different combinations.

The described memory and storage control coordination provides several technical advantages for device performance and power efficiency. Through bypassing the coherent interconnect, the architecture avoids multi-interconnect hubs and systemic bottlenecks, thereby achieving significantly higher effective throughput. Eliminating the AXI wrapping and flit-packetization overhead can achieve a 25 to 30 percent reduction in data transfer latency. Additionally, enabling relatively aggressive memory power-collapse operations yields significant power savings. For electronic devices like smartwatches or mobile phones, reducing the DRAM self-refresh periods during idle times can increase battery life by multiple hours. In fact, the larger the size of the DRAM, the more battery life is increased. Further, power is also saved with the suspend-to-disk state if the volatile memory includes static random-access memory (SRAM). These and other implementations and advantages are described further herein.

### Example Electronic Devices and Environments

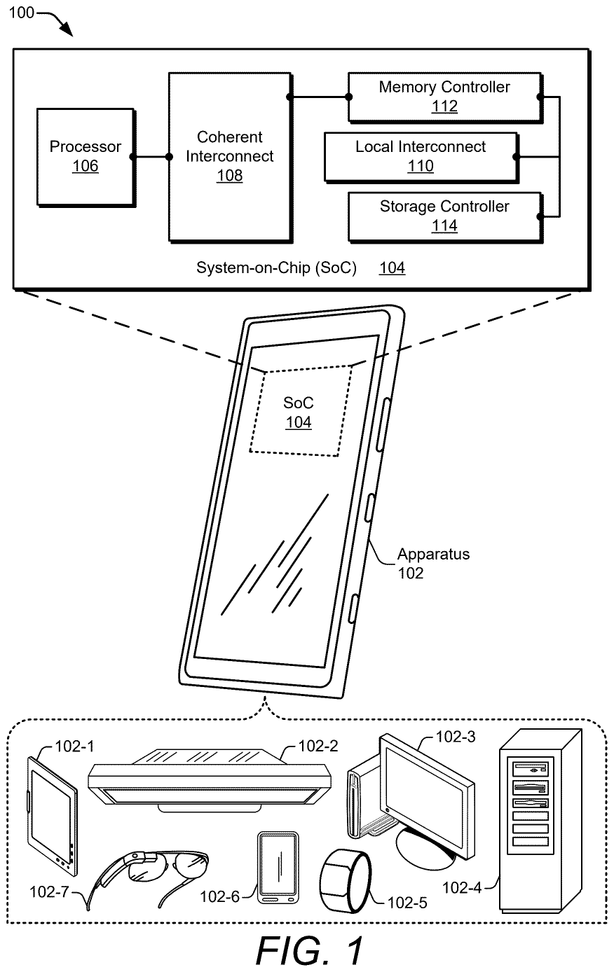

FIG. 1 illustrates, at 100 generally, an example apparatus 102 including a system-on-chip 104 (SoC 104) having a local interconnect 110 coupled to a memory controller 112 and a storage controller 114 that can implement memory and storage control coordination. As shown, the apparatus 102 includes the SoC 104. The SoC 104 includes at least one processor 106, at least one coherent interconnect 108, at least one local interconnect 110, at least one memory controller 112, and at least one storage controller 114. In the example of FIG. 1, the apparatus 102 is depicted as a smartphone.

The apparatus 102 may, however, be implemented as any suitable computing or other electronic device as described herein. Examples of the apparatus 102 include a mobile electronic device or mobile device, mobile communication device, modem, cellular or mobile phone, mobile station or user equipment (UE), gaming device, navigation device, media or entertainment device (e.g., a media streamer or gaming controller), laptop computer, desktop computer, tablet computer, smart appliance, vehicle-based electronic system, wearable computing device (e.g., clothing, watch, or augmented-reality (AR) glasses), Internet of Things (IoTs) device, sensor, stock management device, electronic portion of a machine or piece of equipment (e.g., a vehicle or robot), memory storage device (e.g., a solid-state drive (SSD)), server computer or portion thereof (e.g., a server blade or rack or another part of a datacenter), and the like. Illustrated examples of the apparatus 102 include a tablet device 102-1, a smart television 102-2, a desktop computer 102-3, a server computer 102-4, a smartwatch 102-5, a smartphone 102-6 (or document reader), and intelligent glasses 102-7.

In example implementations, the processor 106 is coupled to the coherent interconnect 108. The memory controller 112 is coupled to the coherent interconnect 108 and the local interconnect 110. The memory controller 112 is configured to communicate with the processor 106 using the coherent interconnect 108. The storage controller 114 is coupled to the local interconnect 110. The storage controller 114 is configured to bypass the coherent interconnect 108 by communicating with the memory controller 112 using the local interconnect 110. Through bypassing the coherent interconnect 108, the SoC 104 can avoid routing overhead and accelerate data transfers between the storage controller 114 and the memory controller 112. This acceleration can facilitate robust power-saving operations for the apparatus 102 as is described herein. Next, however, this document describes an alternative approach that omits a local interconnect coupling the

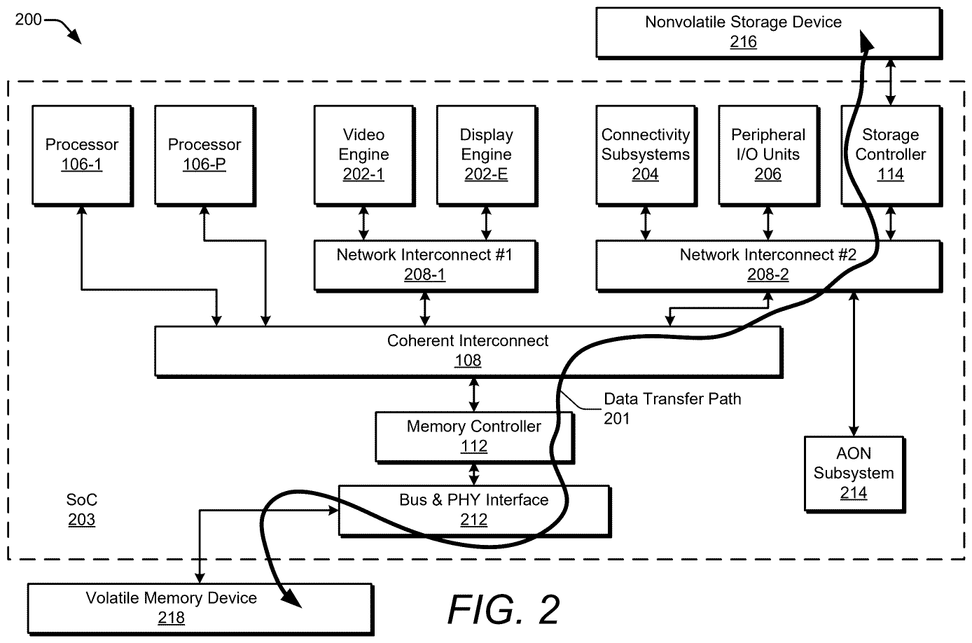

FIG. 2 is an example schematic diagram 200 of an SoC 203 utilizing a different approach in which a memory controller 112 and a storage controller 114 lack control coordination and instead communicate across a coherent interconnect 108. As shown in the example of FIG. 2, the SoC 203 includes at least one processor 106-1, at least one processor 106-P, at least one video engine 202-1, at least one display engine 202-E, one or more connectivity subsystems 204, and one or more peripheral I/O units 206. The SoC 203 also includes a network interconnect #1 208-1, a network interconnect #2 208-2, at least one coherent interconnect 108, at least one memory controller 112, and at least one storage controller 114. The SoC 203 further includes at least one instance of an always-on (AON) subsystem 214 and at least one bus and physical (PHY) interface 212. The SoC 203 is communicatively coupled to a nonvolatile storage device 216 and a volatile memory device 218. A data transfer path 201 illustrates a route for moving data from the nonvolatile storage device 216 to the volatile memory device 218.

In example operations, moving data utilizing this alternative approach that lacks control coordination entails multi-stage routing along the data transfer path 201. The data transfer path 201 moves data from the nonvolatile storage device 216 to the storage controller 114, which organizes the data into packets. The data transfer path 201 then continues with the network interconnect #2 208-2, where the data is broken into smaller chunks, like flits having a size of sixteen to sixty-four bytes, to fit an available bus width. From the network interconnect #2 208-2, the data transfer path 201 traverses the coherent interconnect 108 to reach the memory controller 112. The memory controller 112 then reassembles the data from the smaller chunks. The memory controller 112 then writes the reassembled data to the volatile memory device 218 via the bus and PHY interface 212.

This multi-stage data transfer path 201 introduces significant protocol overhead and fabric congestion. For example, using a system bus protocol, like an Advanced eXtensible Interface (AXI) protocol for traversing the coherent interconnect 108, adds transaction wrapping overhead to each data burst. Furthermore, the storage data routed along the data transfer path 201 competes for bandwidth with active data traffic generated by any of the processor 106-1, the processor 106-P, the video engine 202-1, and the display engine 202-E. This bandwidth competition across the coherent interconnect 108 can cause data stalls and increase memory access latency still further.

Because of the latency bottlenecks introduced by the data transfer path 201, the SoC 203 may maintain the volatile memory device 218 in a self-refresh state to preserve system, operating system, and application data during idle periods. Retaining this large memory footprint consumes a massive amount of battery power, sometimes accounting for 30 to 45 percent of an idle power budget. This is true for dynamic random-access memory (DRAM) that uses refresh operations to maintain data and for static random-access memory (SRAM) that uses constant power to maintain data. Although the volatile memory device 218 can be powered off entirely during deep sleep or suspend-to-disk modes, restoring system state data using the data transfer path 201 across the coherent interconnect 108 can involve a warm boot sequence consuming 5 to 10 seconds to complete.

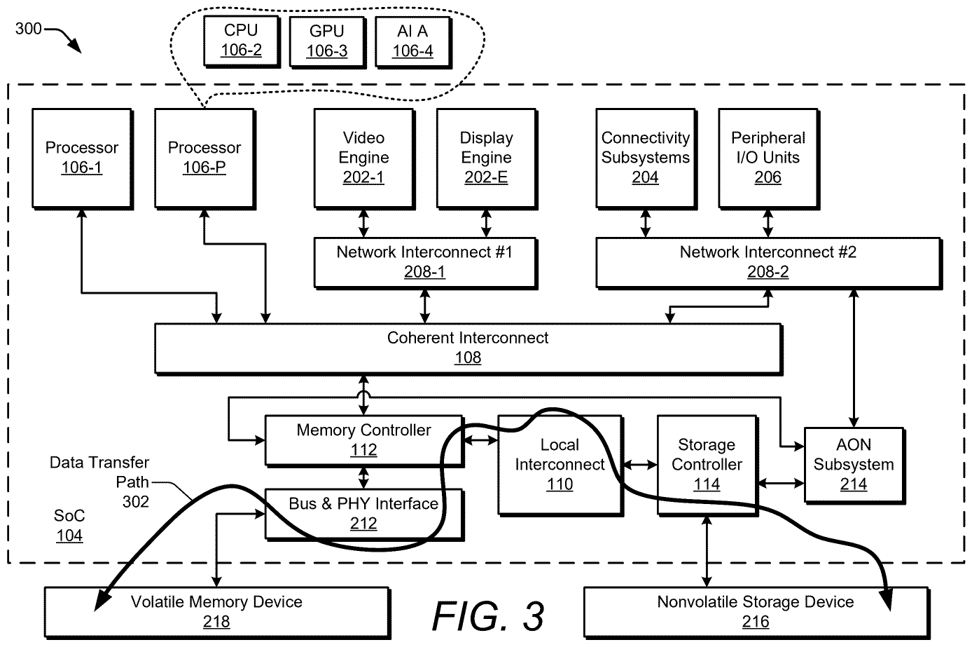

A substantial portion of this boot time is devoted to transferring system state data from the storage controller 114 to the memory controller 112 across the coherent interconnect 108. Due to the extended boot time, operating systems may avoid suspending operations and preserving system state in the nonvolatile storage device 216 for short idle periods due to the severe bandwidth bottlenecks and power efficiency impacts imposed by the data transfer path 201. This causes electronic devices to enter power-saving deep-sleep states less frequently or for a lower percentage of overall time. These effects cause devices to have shorter battery lives. In contrast, other approaches that are described herein involve coordination between a storage controller 114 and a memory controller 112 to facilitate more frequent use of deep-sleep states to thereby extend battery life. Example architectures of such approaches are described next with reference to FIG. 3.

### Example Apparatuses and Operational Schemes

FIG. 3 is an example schematic diagram 300 of a system-on-chip 104 (SoC 104) in which a memory controller 112 and a storage controller 114 coordinate control and communicate across a local interconnect 110 in accordance with memory and storage control coordination as described herein. As shown in the example of FIG. 3, the schematic diagram 300 includes the SoC 104, a nonvolatile storage device 216, and a volatile memory device 218. The SoC 104 includes “P” instances of a processor 106, from a first processor 106-1 to a “Pth” processor 106-P, where “P” represents an integer of one or more. The “P” instances of the processor 106 can include a central processing unit 106-2 (CPU 106-2), a graphics processing unit 106-3 (GPU 106-3), an artificial-intelligence accelerator 106-4 (AI A 106-4), and so forth. The SoC 104 also includes “E” instances of an engine 202, including a video engine 202-1 and a display engine 202-E, where “E” represents an integer greater than one.

Continuing with the FIG. 3 example, the SoC 104 further includes one or more connectivity subsystems 204, one or more peripheral I/O units 206, at least one network interconnect #1 208-1, at least one network interconnect #2 208-2, and at least one coherent interconnect 108. The SoC 104 also incorporates at least one memory controller 112, at least one local interconnect 110, at least one storage controller 114, at least one instance of an always-on (AON) subsystem 214, and at least one bus and physical (PHY) interface 212. FIG. 3 also illustrates a data transfer path 302 that extends from the nonvolatile storage device 216 to the volatile memory device 218. An SoC 104 may, however, include more, fewer, or different components than those shown in FIG. 3. Further, the components may be coupled together in alternative manners.

In example implementations, the various components of the SoC 104 provide different functionality for an electronic device. The “P” instances of the processor 106, which are coupled to the coherent interconnect 108, execute operating systems and applications. Specifically, the CPU 106-2 can handle general-purpose computing tasks, the GPU 106-3 can render graphics, and the AI accelerator 106-4 can accelerate the execution of machine learning (ML) models. The “E” instances of the engine 202, like the video engine 202-1 and the display engine 202-E, process multimedia workloads and composite images for a display screen. Each engine 202 is coupled to the network interconnect #1 208-1, which is coupled to the coherent interconnect 108.

The connectivity subsystems 204 can manage wireless communications, like Wi-Fi®, Bluetooth®, or cellular communications. The peripheral I/O units 206 can manage data input and output from external sensors or accessories. The connectivity subsystems 204 and the peripheral I/O units 206 are coupled to the network interconnect #2 208-2, which is coupled to the coherent interconnect 108. External of the SoC 104 is at least one nonvolatile storage device 216 and at least one volatile memory device 218. The nonvolatile storage device 216 can be realized with, for instance, a flash memory device, in which case the storage controller 114 can be a flash memory controller. The volatile memory device 218 can be realized with, for example, DRAM or SRAM, in which for the former case the memory controller 112 can be a DRAM controller.

To facilitate communication across the SoC 104, the components can be communicatively coupled together in various configurations, some examples of which are shown in FIG. 3. The video engine 202-1 and the display engine 202-E are coupled to the network interconnect #1 208-1. The connectivity subsystems 204 and the peripheral I/O units 206 are coupled to the network interconnect #2 208-2. The network interconnect #1 208-1, the network interconnect #2 208-2, and the “P” instances of the processor 106 are each coupled to the coherent interconnect 108. In some cases, the coherent interconnect 108 maintains cache coherency and manages system-wide data routing. The always-on subsystem 214 is coupled to the network interconnect #2 208-2, the storage controller 114, and the memory controller 112.

In further example implementations, the memory controller 112 is coupled to the coherent interconnect 108 and the local interconnect 110. The memory controller 112 communicates with the “P” instances of the processor 106 using the coherent interconnect 108. The memory controller 112 also communicates with the volatile memory device 218 via the bus and PHY interface 212. The storage controller 114 is coupled to the local interconnect 110. The storage controller 114 can also include an integrated PHY (not shown) to communicate directly with the nonvolatile storage device 216. In contrast, but by way of example only, the bus and PHY interface 212 can be coupled between the memory controller 112 and the volatile memory device 218. The bus and PHY interface 212 may be integrated on the SoC 104. Although not shown in FIG. 3, the storage controller 114 may be coupled to the coherent interconnect 108 such that the storage controller 114 can exchange data with the coherent interconnect 108 without using the memory controller 112 or the local interconnect 110. Similarly, although not shown in FIG. 3, the local interconnect 110 may be coupled to the coherent interconnect 108 such that the local interconnect 110 can exchange data with the coherent interconnect 108 without using the memory controller 112 (or the storage controller 114).

In example operations, the storage controller 114 is configured to bypass the coherent interconnect 108 by communicating with the memory controller 112 using the local interconnect 110. The data transfer path 302 depicts an example shorter or accelerated route (as compared to the data transfer path 201 of FIG. 2) for moving data from the nonvolatile storage device 216 to the volatile memory device 218 that leverages the described memory and storage control coordination. The storage controller 114 is configured to bypass the coherent interconnect 108 by sending data from the storage controller 114 to the memory controller 112 using the local interconnect 110 along the data transfer path 302. Thus, the data transfer path 302 avoids the network interconnect #2 208-2 and the coherent interconnect 108 entirely. Instead, the data transfer path 302 provides a dedicated, localized conduit between the storage controller 114 and the memory controller 112. As indicated by the double-headed arrow representing the data transfer path 302, data can also be transferred from the volatile memory device 218 to the nonvolatile storage device 216 and from the memory controller 112 to the storage controller 114 using the local interconnect 110.

This coordinated architecture provides technical advantages over the multistage routing approach that lacks control coordination, which is depicted in FIG. 2. By bypassing the coherent interconnect 108, the storage controller 114 and the memory controller 112 can avoid significant protocol overhead associated with coherent transactions. Moreover, through bypassing the coherent interconnect 108, the storage controller 114 avoids competing with active data traffic generated by the processor 106, the video engine 202-1, and other blocks. This eliminates system-level fabric congestion and prevents the data stalls that result from the multistage data transfer path 201 of FIG. 2. Consequently, streaming data along the data transfer path 302 via the local interconnect 110 achieves significantly higher effective throughput between the memory controller 112 and the storage controller 114. This localized data routing mechanism can achieve a 25 to 30 percent reduction in data-access latency compared to the multistage routing approach of FIG. 2. Further, an electronic device can leverage this increased throughput and reduced data-access latency to enable power savings by entering reduced power states more frequently or for shorter periods of time.

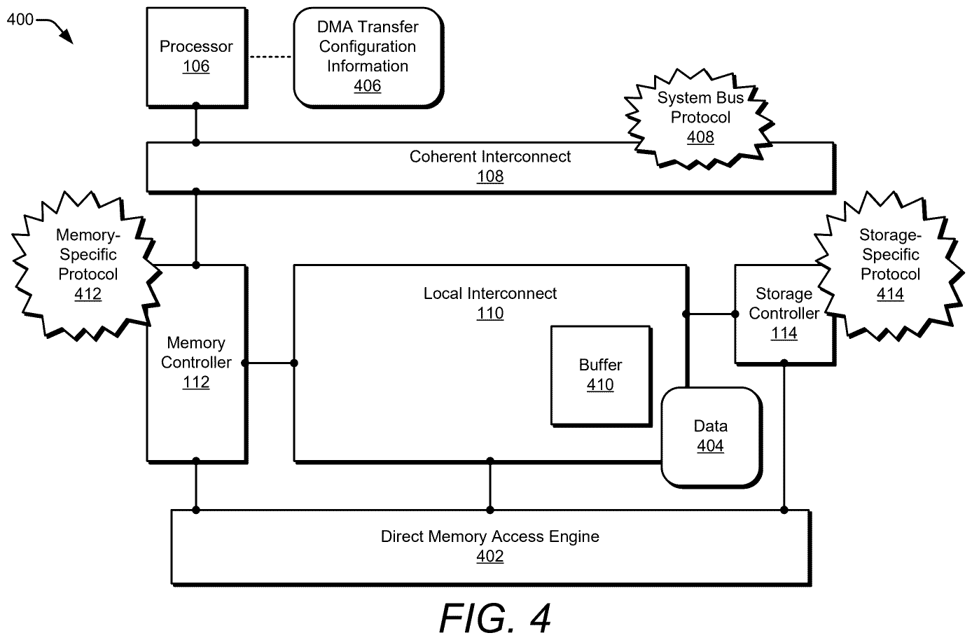

FIG. 4 illustrates an example arrangement 400 detailing approaches to implementing memory and storage control coordination as described herein. As shown for the examples of FIG. 4, the arrangement 400 includes the processor 106, the coherent interconnect 108, the local interconnect 110, the memory controller 112, and the storage controller 114 as described above. The arrangement 400 also includes or is related to at least one direct memory access engine 402 (DMA engine 402), at least one instance of data 404, at least one instance of DMA transfer configuration information 406, at least one system bus protocol 408, at least one buffer 410, at least one memory-specific protocol 412, and at least one storage-specific protocol 414. In this scenario, the coherent interconnect 108 corresponds to the system bus protocol 408. The memory controller 112 operates in accordance with the memory-specific protocol 412, and the storage controller 114 operates in accordance with the storage-specific protocol 414.

Continuing with the example illustration of FIG. 4, the direct memory access engine 402 is coupled to the memory controller 112, the local interconnect 110, and the storage controller 114. The local interconnect 110 includes the at least one buffer 410. The buffer 410 can be implemented with, for example, a queue, a first-in first-out (FIFO) buffer, a cache, some combination thereof, and so forth. Although not so depicted for clarity in FIG. 4, the data 404 may be transferred from the nonvolatile storage device 216 to the volatile memory device 218 (e.g., both of FIG. 3) by the storage controller 114 and the memory controller 112.

In example implementations, the direct memory access engine 402 is configured to execute a transfer of the data 404 between the storage controller 114 and the memory controller 112 using the local interconnect 110 and bypassing the coherent interconnect 108. The processor 106 can initiate the transfer by generating and then transmitting the DMA transfer configuration information 406 to the direct memory access engine 402. The DMA transfer configuration information 406 can include a starting memory address, an ending memory address, and a copy command. The direct memory access engine 402 may execute the transfer of the data 404 between the storage controller 114 and the memory controller 112 without oversight by the processor 106 after the transfer of data is initiated by the processor 106.

During the execution of the transfer of the data 404, the storage controller 114 and the memory controller 112 are configured to cooperate to translate from the storage-specific protocol 414 to the memory-specific protocol 412 to bypass the system bus protocol 408. The system bus protocol 408 can include, for instance, an Advanced eXtensible Interface (AXI) protocol that entails packetizing data payloads into flits and appending protocol transaction overhead. By way of example only, the storage-specific protocol 414 can include a Universal Flash Storage (UFS) protocol, like a UFS 3.1 or UFS 4.0 protocol, or an embedded MultiMediaCard (eMMC) protocol. The storage-specific protocol 414 can also entail utilizing a UFS Protocol Information Unit (UPIU) packet structure. The memory-specific protocol 412 can include a Low-Power Double-Data-Rate (LPDDR) protocol, like an LPDDR5, LPDDR5x, or LPDDR6 protocol. Additionally or alternatively, the memory-specific protocol 412 can include a standard Double-Data-Rate (DDR) protocol, or a DDR physical layer (PHY) interface (DFI) protocol considering data propagation to or through the bus and PHY interface 212 (e.g., of FIG. 3). In some cases, the storage controller 114 and the memory controller 112 are configured to cooperate to translate from the storage-specific protocol 414 to the memory-specific protocol 412 without packetizing the data 404 in accordance with the system bus protocol 408.

In operation, the storage controller 114 and the memory controller 112 are configured to cooperate to stream the data 404 from the storage controller 114 to the memory controller 112 over the local interconnect 110 using the at least one buffer 410. The at least one buffer 410 can include, for instance, at least one FIFO buffer. This avoids breaking the data 404 into small flits to navigate the coherent interconnect 108. This cooperation can enable the two controllers to stream the data 404 from the storage controller 114 to the memory controller 112 in contiguous chunks, which can have a size of four kilobytes (4 KB), 16 kilobytes (16 KB), or larger. The streaming of the data 404 in page-sized contiguous chunks provides appreciable bandwidth advantages. The streaming can be performed while the memory controller 112 maintains a DRAM row in an open state. Maintaining the DRAM row in an open state increases the data throughput from the storage controller 114 into the volatile memory device 218 (e.g., of FIG. 3), realizing increased latency-reduction benefits of the memory and storage control coordination.

In other example implementations, the memory controller 112 and the storage controller 114 can be integrated together. For example, the memory controller 112 and the storage controller 114 may be fabricated as a single, unified controller hardware block on the SoC 104. In such integrated configurations, the local interconnect 110 can be realized as an internal data bus or internal routing logic that is disposed within the unified controller hardware block from a logical perspective. Consequently, the storage controller 114 can bypass the coherent interconnect 108 by communicating with the memory controller 112 internally via the local interconnect 110. This physical integration that increases the physical proximity between the memory controller 112 and the storage controller 114 can further reduce physical trace routing distances across the SoC 104. By consolidating these two components, the SoC 104 can further decrease data transfer latencies and lower dynamic power consumption during storage-to-memory and memory-to-storage streaming operations. Additionally or alternatively, this integration can enable the memory controller 112 and the storage controller 114 to physically share local hardware resources, like the at least one buffer 410 or the direct memory access engine 402, thereby reducing an overall silicon area utilized by the SoC 104.

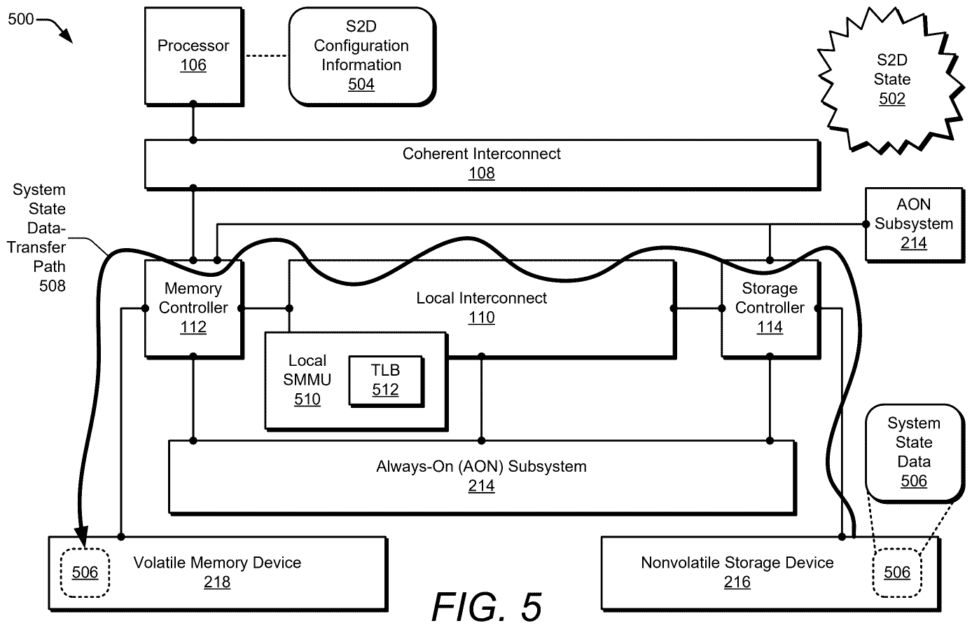

FIG. 5 illustrates an example arrangement 500 detailing approaches to implementing memory and storage control coordination as described herein. As shown for the examples of FIG. 5, the arrangement 500 includes the processor 106, the coherent interconnect 108, the local interconnect 110, the memory controller 112, and the storage controller 114. The arrangement 500 also includes the nonvolatile storage device 216, the volatile memory device 218, and an always-on (AON) subsystem 214. The arrangement 500 further includes or relates to a suspend-to-disk (S2D) state 502, suspend-to-disk configuration information 504, system state data 506, a system state data-transfer path 508, a local system memory management unit 510 (local SMMU 510), and a hardware translation lookaside buffer 512 (TLB 512).

In example implementations, the always-on subsystem 214 is coupled to the memory controller 112 and the storage controller 114 so that the always-on subsystem 214 can control a power-up sequence. This power-up sequence may include providing power and at least initial control signaling to the memory controller 112 or the storage controller 114. The local system memory management unit 510 is coupled to the local interconnect 110 to monitor memory addresses. The local system memory management unit 510 can include the hardware translation lookaside buffer 512 to facilitate memory address checking.

In example operations, an apparatus is configured to transition into the suspend-to-disk state 502 (S2D state 502) in which the volatile memory device 218 that is coupled to the memory controller 112 is power-collapsed. Power-collapsing the volatile memory device 218 eliminates the self-refresh power drain associated with DRAM or the constant power drain associated with SRAM, thereby extending battery life. As used herein, the term “suspend-to-disk” may include hibernate, deep sleep, safe sleep, S4 state, and so forth. The term “disk” can include any solid-state or other drive that retains data without power. Prior to power-collapsing the volatile memory device 218, the processor 106 can generate the suspend-to-disk configuration information 504. Based on the suspend-to-disk configuration information 504, the system state data 506 is stored in the nonvolatile storage device 216 that is coupled to the storage controller 114. Although not explicitly depicted in FIG. 5, the system state data 506 can be transferred from the volatile memory device 218 to the nonvolatile storage device 216 via the local interconnect 110 prior to entering the suspend-to-disk state 502.

Because the local interconnect 110 eliminates significant data routing overhead and accelerates data transfers, the apparatus can leverage the suspend-to-disk state 502 far more aggressively to save more power. For instance, the apparatus can be configured to trigger the suspend-to-disk state 502 based on approximately ten (10) minutes of actual idle time, approximately fifteen (15) minutes of predicted idle time, some combination thereof, and so forth. In this context, the term “approximately” can connote a value within 5%, 10%, or even 25% of the stated value. This more-frequent transition into deep sleep during shorter idle periods provides substantial power conservation that was previously unachievable due to lengthy fabric-routing latencies.

During the suspend-to-disk state 502, the always-on subsystem 214 is configured to remain powered. The always-on subsystem 214 is configured to execute a wake-up sequence to restore the system state data 506 from the nonvolatile storage device 216 upon exiting the suspend-to-disk state 502. The wake-up sequence can include multiple operations. For example, the wake-up sequence can include triggering power to be supplied to the memory controller 112 and the storage controller 114. The wake-up sequence can also include streaming the system state data 506 from the storage controller 114 to the memory controller 112 using the local interconnect 110 and bypassing the coherent interconnect 108 along the system state data-transfer path 508. The wake-up sequence can further include releasing the at least one processor 106 from a reset state responsive to the streaming.

While the system state data 506 is streaming or at other times, the local system memory management unit 510 can manage data transfers propagated over the local interconnect 110 between the storage controller 114 and the memory controller 112. The local system memory management unit 510 can, for example, perform address validation for the data transfers. By utilizing the hardware translation lookaside buffer 512, the local system memory management unit 510 can perform in-line address validation without executing remote table walks across the coherent interconnect 108. Through this address validation, the local system memory management unit 510 can confine storage-to-memory transfers to predetermined safe address ranges. This hardware-enforced sandboxing protects a restored operating system kernel from accidental or malicious overwriting during the wake-up sequence. For example, during suspend-to-disk transitions, the AON subsystem 214 can take control of the system memory management unit configuration to provide a hardware-rooted “safe address range” that ensures the hibernation image of the operating system is restored to verified memory footprints, thereby protecting the kernel from accidental or malicious overwrites during the restoration sequence.

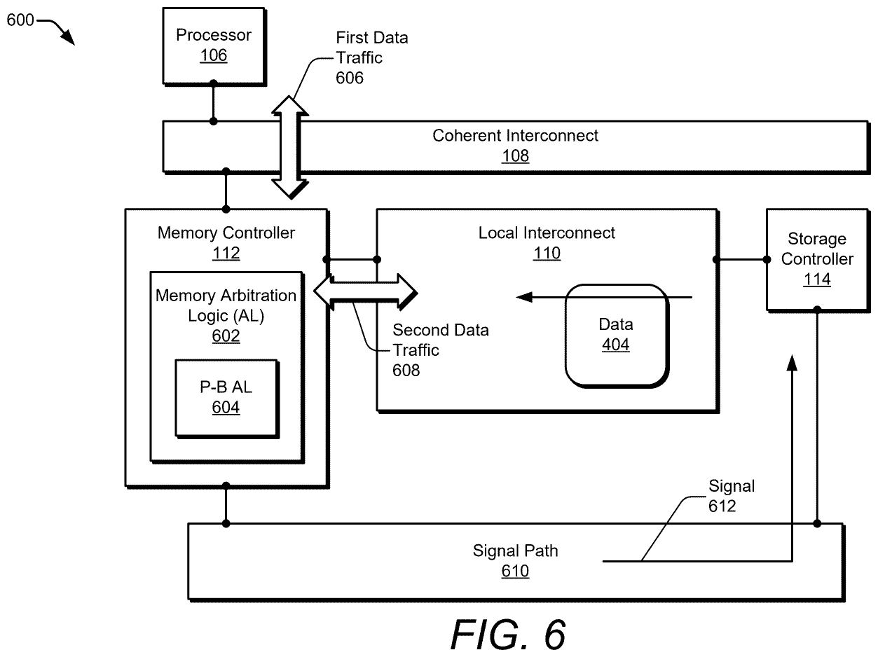

FIG. 6 illustrates an example arrangement 600 detailing additional approaches to implementing memory and storage control coordination as described herein. As shown for the examples of FIG. 6, the arrangement 600 includes the processor 106, the coherent interconnect 108, the memory controller 112, the local interconnect 110, the storage controller 114, and the data 404. The arrangement 600 also includes memory arbitration logic 602, priority-based arbitration logic 604 (P-B AL 604), first data traffic 606, second data traffic 608, a signal path 610, and a signal 612.

In example implementations, the memory controller 112 includes the memory arbitration logic 602. The memory arbitration logic 602 can include the priority-based arbitration logic 604. The signal path 610 is coupled between the memory controller 112 and the storage controller 114. The signal path 610 can be realized with a single signaling wire connecting the two controllers, which wire can be used for sideband pressure signaling. The first data traffic 606 is propagated over the coherent interconnect 108, and the second data traffic 608 is propagated over the local interconnect 110.

In example operations, high-speed streaming of the data 404 from the storage controller 114 to the memory controller 112 risks saturating the memory controller 112 and causing congestion with respect to traffic over the coherent interconnect 108. To mitigate such congestion, the memory arbitration logic 602 is configured to allocate memory bandwidth between the first data traffic 606 with the coherent interconnect 108 and the second data traffic 608 with the local interconnect 110. In some cases, the priority-based arbitration logic 604 prioritizes the first data traffic 606 over the second data traffic 608 to prevent bandwidth starvation of the processor 106. Alternatively or additionally, the memory arbitration logic 602 can transmit the signal 612 to the storage controller 114 via the signal path 610 to cause the storage controller 114 to throttle a data transfer speed of the data 404 being transmitted from the storage controller 114 to the memory controller 112 over the local interconnect 110. By dynamically throttling the data 404 or by prioritizing the processor 106, the memory controller 112 can avoid data stalls and ensure system responsiveness during large storage-to-memory transfers.

Aspects of the described techniques may be implemented in, for example, hardware (e.g., fixed logic circuitry, a controller, a finite state machine, or a processor in conjunction with a memory), firmware, software, or some combination thereof. The techniques may be realized to produce or implement one or more of the apparatuses or components shown in FIGS. 1 and 3-6, which components may be further divided, combined, and so on. The devices and components of these figures generally represent hardware, such as electronic devices, PCBs, packaged modules, IC chips, components, or circuits; firmware; software; or a combination thereof. Thus, these figures illustrate some of the many possible systems or apparatuses capable of being realized in accordance with the described techniques.

For the techniques described herein, the orders in which operations are shown and/or described are not intended to be construed as a limitation. Instead, any number or combination of the described operations can be combined in any order to implement a given technique or an alternative technique, including by combining operations from different descriptive portions with other described schemes and techniques. Operations may also be omitted from or added to the described techniques. Further, described operations can be implemented in fully or partially overlapping manners.

### Additional Example Apparatuses and Electronic Devices

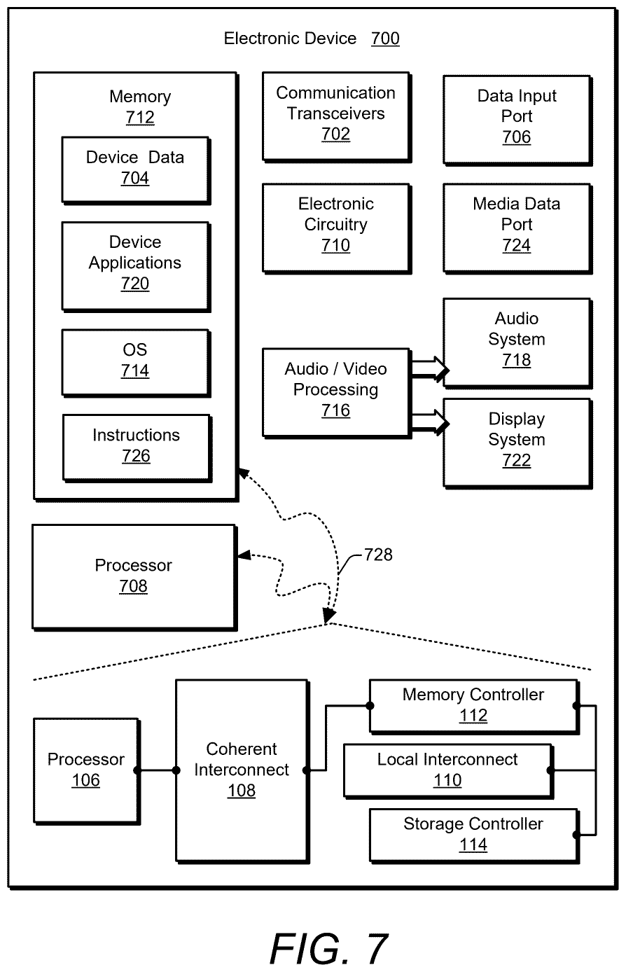

FIG. 7 illustrates various components of an example electronic device 700 that can implement memory and storage control coordination in accordance with one or more described aspects. The electronic device 700 may be implemented as any one or combination of a fixed, mobile, stand-alone, or embedded device or in any form of a consumer, computer, portable, user, server, communication, phone, navigation, gaming, audio, camera, messaging, media playback, and/or other type of electronic device 700, such as the smartphone that is depicted in FIG. 1 as the apparatus 102. One or more of the illustrated components may be realized as discrete components or as integrated components on at least one integrated circuit of the electronic device 700 or separately or jointly in one or more packages of the electronic device 700.

The electronic device 700 can include one or more communication transceivers 702 that enable wired and/or wireless communication of device data 704, such as received data, transmitted data, or other information identified above. Example communication transceivers 702 include near-field communication (NFC) transceivers, wireless personal area network (PAN) (WPAN) radios compliant with various IEEE 802.15 (Bluetooth®) standards, wireless local area network (LAN) (WLAN) radios compliant with any of the various IEEE 802.11 (Wi-Fi®) standards, wireless wide area network (WAN) (WWAN) radios (e.g., those that are 3GPP-compliant) for cellular telephony, wireless metropolitan area network (MAN) (WMAN) radios compliant with various IEEE 802.16 (WiMAX™) standards, infrared (IR) transceivers compliant with an Infrared Data Association (IrDA) protocol, and wired local area network (LAN) (WLAN) Ethernet transceivers.

The electronic device 700 may also include one or more data input ports 706 via which any type of data, media content, and/or other inputs can be received, such as user-selectable inputs, messages, applications, music, television content, recorded video content, and any other type of audio, video, and/or image data received from any content and/or data source, including a sensor like a microphone or a camera. The data input ports 706 may include USB ports, coaxial cable ports, fiber optic ports for optical fiber interconnects or cabling, and other serial or parallel connectors (including internal connectors) for flash memory, DVDs, CDs, and the like. These data input ports 706 may be used to couple the electronic device to components, peripherals, or accessories such as keyboards, microphones, cameras, or other sensors.

The electronic device 700 of this example includes one or more processors 708 (e.g., any one or more of application processors, microprocessors, digital-signal processors (DSPs), controllers, and the like), which can include a combined processor and memory system (e.g., implemented as part of an SoC), that execute (e.g., process or otherwise implement) processor-executable instructions 726 (e.g., computer-executable instructions) to control operation of the device. The processor 708 may be implemented as an application processor, embedded controller, microcontroller, security processor, artificial intelligence (AI) accelerator, and the like. Generally, a processor or processing system may be implemented at least partially in hardware, which can include components of an integrated circuit or on-chip system, a digital signal processor (DSP), an application-specific integrated circuit (ASIC), a field programmable gate array (FPGA), a complex programmable logic device (CPLD), and other implementations in silicon and/or other materials.

Alternatively or additionally, the electronic device 700 can be implemented with any one or combination of electronic circuitry, which may include software, hardware, firmware, or fixed logic circuitry that is implemented in connection with processing and control circuits, which are generally indicated at 710 (as electronic circuitry 710). This electronic circuitry 710 can implement executable or hardware-based modules (not shown in FIG. 7), such as through processing/computer-executable instructions stored on computer-readable media, through logic circuitry and/or hardware (e.g., such as an FPGA), and so forth.

The electronic device 700 can include a system bus, interconnect, crossbar, data transfer system, switch fabric, or other communication fabric that couples the various components within the device. A system bus or interconnect can include any one or a combination of different bus structures, such as a memory bus or memory controller, a peripheral bus, a universal serial bus (USB), and/or a processor or local bus that utilizes any of a variety of bus architectures.

The electronic device 700 also includes at least one memory 712 (e.g., one or more memory devices 712) that enables data storage, examples of which include random-access memory (RAM), non-volatile memory (e.g., read-only memory (ROM), flash memory, EPROM, and EEPROM), and a disk storage device. Thus, the at least one memory 712 can be distributed across different logical storage levels of a system as well as at different physical components. The memory 712 provides data storage mechanisms to store the processor-executable instructions 726, the device data 704, other types of code and/or data, and various device applications 720 (e.g., software applications or programs). For example, an operating system 714 can be maintained as software instructions within the memory 712 and executed by the processor 708.

In some implementations, the electronic device 700 also includes an audio and/or video processing system 716 that processes audio and/or video data and/or that passes through the audio and/or video data to an audio system 718 and/or to a display system 722 (e.g., a video buffer or a screen of a smartphone or camera). The audio system 718 and/or the display system 722 may include any devices that process, display, and/or otherwise render or present audio, video, display, and/or image data. Display data and audio signals can be communicated to an audio component and/or to a display component via an RF (radio-frequency) link, an S-video link, an HDMI (high-definition multimedia interface) link, a composite video link, a component video link, a DVI (digital video interface) link, an analog audio connection, a video bus, or another similar communication link, such as a media data port 724. In some implementations, the audio system 718 and/or the display system 722 are external or separate components of the electronic device 700. Alternatively, the display system 722, for example, can be an integrated component of the example electronic device 700, such as part of an integrated touch interface.

The electronic device 700 of FIG. 7 illustrates example implementations of the apparatus 102 of FIG. 1, of an apparatus that utilizes a local interconnect 110 to perform memory and storage control coordination as with any of FIGS. 3 to 6, or some combination thereof. Accordingly, one or more of the components illustrated in FIG. 7 and discussed above may realize or incorporate at least part of the other components depicted in FIG. 7. These other components include the processor 106, the coherent interconnect 108, the memory controller 112, the local interconnect 110, and the storage controller 114. For example, as indicated by the arrows 728, the processor 708 may correspond to the at least one processor 106 and represent a portion of a system-on-chip (SoC) 104 (e.g., of FIGS. 1 and 3) that also incorporates the coherent interconnect 108, the memory controller 112, the local interconnect 110, and the storage controller 114. Further, the memory 712 may realize the volatile memory device 218 or the nonvolatile storage device 216 (e.g., of FIGS. 3 and 5). Furthermore, the electronic circuitry 710 may realize at least part of the direct memory access engine 402 (e.g., of FIG. 4), the always-on (AON) subsystem 214 (e.g., of FIG. 5), or the memory arbitration logic 602 (e.g., of FIG. 6) to govern accelerated data transfers.

### Example Aspects and Implementations for Memory and Storage Control Coordination

In the following, some examples, example aspects, and implementations are described:
Example 1: An apparatus comprising: a coherent interconnect; at least one processor coupled to the coherent interconnect; a local interconnect; a memory controller coupled to the coherent interconnect and the local interconnect, the memory controller configured to communicate with the at least one processor using the coherent interconnect; and a storage controller coupled to the local interconnect, the storage controller configured to bypass the coherent interconnect by communicating with the memory controller using the local interconnect.
Example 2: The apparatus of example 1, or any one or more of the examples described herein, wherein: the storage controller is configured to bypass the coherent interconnect by sending data from the storage controller to the memory controller using the local interconnect.
Example 3: The apparatus of example 2, or any one or more of the examples described herein, wherein: the coherent interconnect corresponds to a system bus protocol; and the storage controller and the memory controller are configured to cooperate to translate from a storage-specific protocol to a memory-specific protocol to bypass the system bus protocol.
Example 4: The apparatus of example 3, or any one or more of the examples described herein, wherein: the storage controller and the memory controller are configured to cooperate to translate from the storage-specific protocol to the memory-specific protocol without packetizing the data in accordance with the system bus protocol.
Example 5: The apparatus of example 3, or any one or more of the examples described herein, wherein: the system bus protocol comprises an Advanced eXtensible Interface (AXI) protocol that entails packetizing data payloads into flits and appending protocol transaction overhead.
Example 6: The apparatus of example 2, or any one or more of the examples described herein, wherein: the local interconnect comprises at least one buffer; and the storage controller and the memory controller are configured to cooperate to stream the data from the storage controller to the memory controller over the local interconnect using the at least one buffer.
Example 7: The apparatus of example 6, or any one or more of the examples described herein, wherein: the storage controller and the memory controller are configured to cooperate to stream the data from the storage controller to the memory controller in contiguous chunks having a size of at least four kilobytes (4 KB) while the memory controller maintains a dynamic random-access memory (DRAM) row in an open state.
Example 8: The apparatus of example 2, or any one or more of the examples described herein, further comprising: a direct memory access (DMA) engine coupled to the local interconnect, the direct memory access engine configured to execute a transfer of the data between the storage controller and the memory controller using the local interconnect and bypassing the coherent interconnect.
Example 9: The apparatus of example 8, or any one or more of the examples described herein, wherein: the direct memory access engine is configured to execute the transfer of the data between the storage controller and the memory controller without oversight by the at least one processor after the transfer of the data is initiated by the at least one processor.
Example 10: The apparatus of example 1, or any one or more of the examples described herein, further comprising: a network interconnect coupled to the coherent interconnect; a video engine coupled to the network interconnect; and a display engine coupled to the network interconnect, wherein: the at least one processor comprises a central processing unit and an artificial-intelligence accelerator.
Example 11: The apparatus of example 10, or any one or more of the examples described herein, wherein: the coherent interconnect, the local interconnect, the memory controller, the storage controller, the network interconnect, the video engine, the display engine, the central processing unit, and the artificial-intelligence accelerator are integrated together on a system-on-chip (SoC).
Example 12: The apparatus of example 11, or any one or more of the examples described herein, further comprising: a nonvolatile storage device coupled to the storage controller; a volatile memory device; and a bus and physical (PHY) interface coupled between the memory controller and the volatile memory device, the bus and PHY interface integrated on the system-on-chip.
Example 13: The apparatus of example 12, or any one or more of the examples described herein, wherein: the volatile memory device comprises dynamic random-access memory (DRAM); the memory controller comprises a DRAM controller; the nonvolatile storage device comprises flash memory; and the storage controller comprises a flash memory controller.
Example 14: The apparatus of example 1, or any one or more of the examples described herein, wherein: the apparatus is configured to transition into a suspend-to-disk (S2D) state in which a volatile memory device that is coupled to the memory controller is power-collapsed and system state data is stored in a nonvolatile storage device that is coupled to the storage controller; and the apparatus further comprises an always-on subsystem configured to: remain powered during the suspend-to-disk state; and execute a wake-up sequence to restore the system state data from the nonvolatile storage device upon exiting the suspend-to-disk state.
Example 15: The apparatus of example 14, or any one or more of the examples described herein, wherein the wake-up sequence comprises: triggering power to be supplied to the memory controller and the storage controller; streaming the system state data from the storage controller to the memory controller using the local interconnect and bypassing the coherent interconnect; and releasing the at least one processor from a reset state responsive to the streaming of the system state data.
Example 16: The apparatus of example 14, or any one or more of the examples described herein, wherein the apparatus is configured to: trigger the suspend-to-disk state based on at least one of approximately ten (10) minutes of actual idle time or approximately fifteen (15) minutes of predicted idle time.
Example 17: The apparatus of example 1, or any one or more of the examples described herein, further comprising: a local system memory management unit (SMMU) configured to manage data transfers propagated over the local interconnect between the storage controller and the memory controller.
Example 18: The apparatus of example 17, or any one or more of the examples described herein, wherein the local system memory management unit is configured to: perform address validation for the data transfers; and confine storage-to-memory transfers to predetermined safe address ranges.
Example 19: The apparatus of example 18, or any one or more of the examples described herein, wherein the local system memory management unit comprises: a hardware translation lookaside buffer (TLB).
Example 20: The apparatus of example 1, or any one or more of the examples described herein, wherein the memory controller comprises: memory arbitration logic configured to allocate memory bandwidth between first data traffic with the coherent interconnect and second data traffic with the local interconnect.
Example 21: The apparatus of example 20, or any one or more of the examples described herein, wherein the memory arbitration logic comprises: priority-based arbitration logic configured to prioritize the first data traffic over the second data traffic to prevent bandwidth starvation of the at least one processor.
Example 22: The apparatus of example 20, or any one or more of the examples described herein, further comprising: a signal path between the memory controller and the storage controller, wherein the memory arbitration logic is configured to transmit a signal via the signal path to cause the storage controller to throttle a data transfer speed of data transmitted from the storage controller to the memory controller over the local interconnect.

The terms “first,” “second,” “third,” and other numeric-related indicators are used herein to identify or distinguish similar or analogous items from one another within a given context—like a particular implementation, a single drawing figure, or a claim. However, this numbering terminology may differ from context to context or from implementation to implementation. Thus, a first item in one context may differ from a first item in another context. For example, an item identified as a “first interconnect” in one context may be identified as a “third interconnect” in another context.

Features described in the context of one example aspect (e.g., a method or an apparatus) may be used in combination with other example aspects (e.g., an apparatus or a method, respectively, or a different method or a different apparatus).

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, c-c-c, and a-b-b-c, or any other ordering or quantity of a, b, and c). Further, items represented in the accompanying figures and terms discussed herein may be indicative of one or more items or terms, and thus reference may be made interchangeably to single or plural forms of the items and terms in this written description.

Although implementations for realizing memory and storage control coordination have been described in language specific to certain features and/or methods, the subject of the appended claims is not necessarily limited to the specific features or methods described. Rather, the specific features and methods are disclosed as example implementations for memory and storage control coordination.

What is claimed is:

1. An apparatus comprising:
a coherent interconnect;
at least one processor coupled to the coherent interconnect;
a local interconnect;
a memory controller coupled to the coherent interconnect and the local interconnect, the memory controller configured to communicate with the at least one processor using the coherent interconnect; and
a storage controller coupled to the local interconnect, the storage controller configured to bypass the coherent interconnect by communicating with the memory controller using the local interconnect.

2. The apparatus of claim 1, wherein:
the storage controller is configured to bypass the coherent interconnect by sending data from the storage controller to the memory controller using the local interconnect.

3. The apparatus of claim 2, wherein:
the coherent interconnect corresponds to a system bus protocol; and
the storage controller and the memory controller are configured to cooperate to translate from a storage-specific protocol to a memory-specific protocol to bypass the system bus protocol.

4. The apparatus of claim 3, wherein:
the storage controller and the memory controller are configured to cooperate to translate from the storage-specific protocol to the memory-specific protocol without packetizing the data in accordance with the system bus protocol.

5. The apparatus of claim 3, wherein:
the system bus protocol comprises an Advanced eXtensible Interface (AXI) protocol that entails packetizing data payloads into flits and appending protocol transaction overhead.

6. The apparatus of claim 2, wherein:
the local interconnect comprises at least one buffer; and
the storage controller and the memory controller are configured to cooperate to stream the data from the storage controller to the memory controller over the local interconnect using the at least one buffer.

7. The apparatus of claim 6, wherein:
the storage controller and the memory controller are configured to cooperate to stream the data from the storage controller to the memory controller in contiguous chunks having a size of at least four kilobytes (4 KB) while the memory controller maintains a dynamic random-access memory (DRAM) row in an open state.

8. The apparatus of claim 2, further comprising:
a direct memory access (DMA) engine coupled to the local interconnect, the direct memory access engine configured to execute a transfer of the data between the storage controller and the memory controller using the local interconnect and bypassing the coherent interconnect.

9. The apparatus of claim 8, wherein:
the direct memory access engine is configured to execute the transfer of the data between the storage controller and the memory controller without oversight by the at least one processor after the transfer of data is initiated by the at least one processor.

10. The apparatus of claim 1, further comprising:
a network interconnect coupled to the coherent interconnect;
a video engine coupled to the network interconnect; and
a display engine coupled to the network interconnect, wherein:
the at least one processor comprises a central processing unit and an artificial-intelligence accelerator.

11. The apparatus of claim 10, wherein:
the coherent interconnect, the local interconnect, the memory controller, the storage controller, the network interconnect, the video engine, the display engine, the central processing unit, and the artificial-intelligence accelerator are integrated together on a system-on-chip (SoC).

12. The apparatus of claim 11, further comprising:
a nonvolatile storage device coupled to the storage controller;
a volatile memory device; and
a bus and physical (PHY) interface coupled between the memory controller and the volatile memory device, the bus and PHY interface integrated on the system-on-chip.

13. The apparatus of claim 12, wherein:
the volatile memory device comprises dynamic random-access memory (DRAM);
the memory controller comprises a DRAM controller;
the nonvolatile storage device comprises flash memory; and
the storage controller comprises a flash memory controller.

14. The apparatus of claim 1, wherein:
the apparatus is configured to transition into a suspend-to-disk (S2D) state in which a volatile memory device that is coupled to the memory controller is power-collapsed and system state data is stored in a nonvolatile storage device that is coupled to the storage controller; and
the apparatus further comprises an always-on subsystem configured to:
remain powered during the suspend-to-disk state; and
execute a wake-up sequence to restore the system state data from the nonvolatile storage device upon exiting the suspend-to-disk state.

15. The apparatus of claim 14, wherein the wake-up sequence comprises:
triggering power to be supplied to the memory controller and the storage controller;
streaming the system state data from the storage controller to the memory controller using the local interconnect and bypassing the coherent interconnect; and
releasing the at least one processor from a reset state responsive to the streaming of the system state data.

16. The apparatus of claim 1, further comprising:
a local system memory management unit (SMMU) configured to manage data transfers propagated over the local interconnect between the storage controller and the memory controller.

17. The apparatus of claim 16, wherein the local system memory management unit is configured to:
perform address validation for the data transfers; and
confine storage-to-memory transfers to predetermined safe address ranges.

18. The apparatus of claim 1, wherein the memory controller comprises:
memory arbitration logic configured to allocate memory bandwidth between first data traffic with the coherent interconnect and second data traffic with the local interconnect.

19. The apparatus of claim 18, wherein the memory arbitration logic comprises:
priority-based arbitration logic configured to prioritize the first data traffic over the second data traffic to prevent bandwidth starvation of the at least one processor.

20. The apparatus of claim 18, further comprising:
a signal path between the memory controller and the storage controller,
wherein the memory arbitration logic is configured to transmit a signal via the signal path to cause the storage controller to throttle a data transfer speed of data transmitted from the storage controller to the memory controller over the local interconnect.
